(19) United States
(12) Patent Application Publication
(10) Pub. No.: US 2020/0000063 A1
(43) Pub. Date: Jan. 2, 2020

(54) MULTI-RING ANIMAL COLLAR WITH VARIABLE RESTRAINT CAPABILITY

(71) Applicant: Robert David Jacobs, Franklin, NY (US)

(72) Inventor: Robert David Jacobs, Franklin, NY (US)

(21) Appl. No.: 16/025,098

(22) Filed: Jul. 2, 2018

(51) Int. Cl. A01K 27/00

(52) U.S. Cl. CPC A01K 27/001; A01K 27/005

(57) ABSTRACT

There is provided a multi-ring animal collar that can be used to restrain the animal or to provide a choking force on the animal. The unit features a plurality of rings spaced around the periphery of the collar thus facilitating attachment of a leash or other restrain at or near the top of the animal's head. This eliminates the need to access the lower area of the animal's neck thereby improving both convenience and safety when attaching the leash to the collar. The collar may be formed from steel chain or the like or from straps of material such as leather or nylon. Multiple rings allow for two modes of operation: restraint or restraint and choking force. These modes are selected by selecting different attachment rings according to the function desired. The varying length of the links that comprise the collar enables the user to impose varying degrees of choking force upon an animal. Stops included on the varying length links halt the increase of the choking force applied to the animal.

### FIELD OF THE INVENTION

The field of the present invention is animal collars, especially those designed to squeeze down on the animal's neck when pulling pressure is applied.

### BACKGROUND OF THE INVENTION

Conventional animal choke chain collars involve a single ring by which to hold or to attach a leash. Typically a conventional choke chain collar has a ring on each end and when placed around the animal's neck one of the rings can be pulled to tighten the collar around the animal's neck (this type of collar is often referred to as a “choke chain”). When the choke chain is on the animal, due to the weight of the rings, they typically fall due to gravity so that the rings are located below animal's neck. This then requires the trainer or user to reach under the animal's neck to find the ring to attach a leash or other device to. Reaching under an animal's neck (i.e., in front of the animal's mouth) can be dangerous. In addition, where an animal is being uncooperative or if the animal is excited (such as if another animal is nearby and is being aggressive), reaching under the animal's neck to attach a leash can waste time during situations where time is of the essence. The trainer or user must search around the animal's neck to find the single ring that is usually at the bottom of the animal's neck due to the weight of the ring and gravity pulling it to the lowest point.

Conventional choke chain collars can be extremely difficult for an older or handicapped person to grab to restrain the animal or attach a leash. The person must reach under the animal to find a ring to grab. For anyone suffering from arthritis or any other condition that hampers one's ability to reach below an animal's neck and grasp a small ring, especially where the ring may be moving if the animal is moving about, this can be a difficult and uncomfortable task.

Furthermore, conventional choke chain collars are dangerous for someone who is not extremely familiar with the animal in question in that animals do not like unfamiliar people reaching under their necks. This can cause extreme difficulties for animal trainers, animal keepers (i.e. dog kennels, zoos), animal sitters, etc.

Traditional coke chain collars are also very dangerous to the animal. An inexperienced person can apply too much choking force on the animal's neck and can easily damage the trachea, larynx and neck bones and muscles of the animal. If the animal is left unattended with the traditional choke chain in place around the animal's neck the ring of the chain can get caught on a fence or other object. The natural tendency of the animal is to pull. This pulling can seriously injure the animal or even result in death.

A need was perceived for a safer, more comfortable, easier to grab and leash collar for all animals. U.S. Pat. No. 6,481,384 to Jacobs sought to solve the problem discussed above. Jacobs proposed a multi-ring animal collar that can be used to restrain an animal but not choke the animal like a traditional choke chain would. The multi-ring collar of Jacobs features a plurality of rings spaced around the periphery of the collar thus facilitating attachment of a leash or other restraint at or near the top of the animal's head at any time. This eliminates the need to access the lower area of the animal's neck thereby improving both convenience and safety when attaching the leash to the collar. The collar of Jacobs may be formed from steel chain or the like or from straps of material such as leather or nylon.

The multiple rings in the collar of Jacobs allows for two modes of operation: restraint or restraint and choking force. These modes are selected by selecting different attachment rings according to the function desired. The design of the collar in Jacobs enables a user to attach a leash to certain rings that, when the trainer pulls it enables the collar to function similarly to a traditional “choke chain” collar but the built-in stops prevent the collar from actually choking the animal whereas a traditional choke chain collar has no stops and could seriously injure the animal. The design of Jacobs also enables a user to attach a leash to other certain rings that enable the collar to function as a “regular” collar (i.e., a collar that does not function as a choke chain).

The dual functionality and ease of attaching the leash to any of several rings dispersed about the collar of Jacobs presents significant benefits and convenience to users. However, the art remains ripe for improvement in certain ways. One such way is that the art currently lacks a collar of multiple functionality such as Jacobs that enables variations in the degree to which the collar imposes a choking force on the animal. The current collar of Jacobs imposes the same degree of choking force regardless of which of the choke force chain rings to which a user attaches a leash. This may be undesirable in certain situations. For example, some animals are more excitable than others (e.g., a puppy versus an adult dog); some animals may require a greater restraining force than other animals (e.g., a large working dog, like a trail hound, versus a dog that is more of a traditional pet, like a golden retriever); and some situations call for a greater degree of restraint than others (e.g., a dog's trip to the veterinarian where the dog encounters numerous other animals versus a leisurely walk). There is therefore a need for a collar that provides a user with the dual functionality of the collar of Jacobs, while also enabling the user to vary the degree of restraint imposed on an animal when different situations call for different degrees of restraint. This is the problem that the invention disclosed herein seeks to solve.

### SUMMARY OF THE INVENTION

The present invention is directed to a collar that has multiple rings any one of which can be quickly and easily grabbed and leashed to contain the animal. One of the hallmarks of the invention is there will always be an attachable ring at the top of the animal's neck and there will be no need to search below the animal's neck for an attachable ring. Any individual can easily grab one of the rings to restrain the animal without having to reach under the animal taking important time searching for a restraining ring. The danger of alarming the animal by reaching under the neck is no longer present.

The present invention also includes the dual functionality of Jacobs, enabling the user to use the collar either as a regular collar (i.e., with no choke function) or as a choke chain. Significantly, however, the present invention is a collar that includes links of varying lengths, and “stops.” As explained herein, the inclusion of chain links of varying lengths and stops at varying locations of the collar's links enables the user to vary the degree of choking force imposed upon the animal. This variance is accomplished by attaching a leash to different rings, as the length of the chain links enables the collar to impose a greater degree of choking force when the leash is attached to certain rings that are attached to chain links of different lengths and the trainer thereafter pulls against the animal.

The collar can be made from a plurality of materials including the most common, steel linked chain.

It is the object of the present invention to provide a safe, effective, easily used collar for any animal requiring such a device. Other advantages will appear hereinafter.

### BRIEF DESCRIPTION OF THE DRAWINGS

FIG. 1 is a perspective view of a multi-ring collar made from steel chain showing three rings that can be used to restrain the animal 7, 8 or 9, as well as three rings 4, 5 or 6 that can be used to apply varied choking force and three stops 7, 8 or 9 that illustrate how the present invention permits a user to vary the amount of choking force imposed upon an animal by attaching a leash to various rings.

FIG. 2 is a perspective view of an alternate embodiment of the collar of FIG. 1 having one segment formed from leather or nylon strapping.

FIG. 3 is a perspective view of another alternate embodiment of the collar of FIG. 1 wherein all chain segments have been replaced by leather or nylon strapping.

FIG. 4 is a perspective view of another alternate embodiment of the collar showing four rings and segments of both chain and leather or nylon strapping.

### DETAILED DESCRIPTION OF THE PREFERRED EMBODIMENT

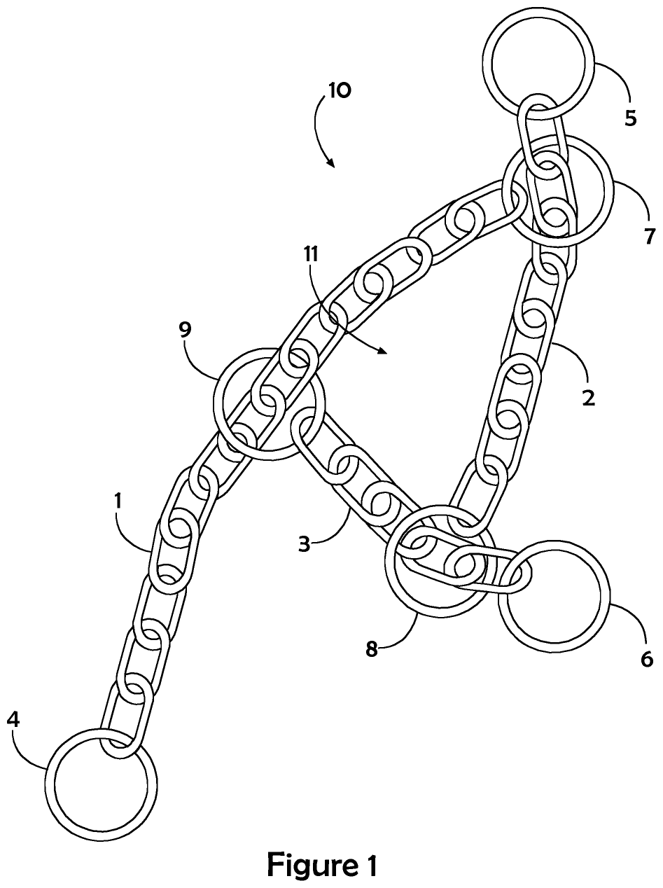

Referring first to FIG. 1, there is shown a perspective view of a first embodiment of the animal collar disclosed herein. A pair of substantially circular rings 4, 7 are joined to one another by a first interconnecting link 1, each end of which is affixed to rings 4, 7. Rings 4, 5, 6, 7, 8, and 9 are each adapted for selectively attaching a leash or other similar restraint (not shown) to collar 10. Attaching a leash to rings 7, 8, or 9 provides animal restraint but substantially no choking action. However, attaching a leash to rings 4, 5, or 6 provides choking action in addition to animal restraint. A second interconnecting link 2 has substantially circular rings 7 and 8 affixed at opposite ends thereof. A third interconnecting link 3 has substantially circular rings 6 and 9 affixed at opposite ends thereof.

This arrangement of links 1, 2, and 3 of collar 10 is such that rings disposed on the ends of each link are unable to pass through any other ring through which links 1, 2, and 3 pass. This results in the creation of collar 10, wherein the open space 11 permits an animals neck to pass through so that the animal may wear the collar 10.

Rings 4, 5, and 6 disposed respectively on the ends of links 1, 2, and 3 permit a user to impose choking force on an animal wearing the collar 10. This choking force, which is akin to a traditional choke chain, results (for one example) by applying a pulling force to ring 4, which results in link 1 being pulled through ring 9 in the direction of ring 4 until ring 7, which is disposed on the opposite end of link 1 from ring 4, reaches ring 9. Ring 7 is designed such that it cannot pass through ring 9 (indeed, all rings are designed so that no ring may pass through any other ring), which stops the choking force from being increased once ring 7 comes into contact with ring 9. Because ring 7 reaching ring 9 stops the choking force from increasing any further in a situation where a leash is applied to ring 4, ring 7 is a “stop.”

Attaching a leash to rings 5 and 6 results in a similar ability of a user to impose a choking force on an animal. When a leash is attached to ring 5 and someone pulls on the leash, link 2 will pass through ring 7 until ring 8 (a stop) contacts ring 7. When a leash is attached to ring 6 and an animal pulls on the leash, link 3 will pass through ring 8 until ring 9 (a stop) contacts ring 8.

Because attaching a leash to rings 7, 8, or 9 (i.e., the stops) does not result in links 1, 2, or 3 being tightened, the attachment of a leash to these rings does not result in a significant choking force being imposed upon an animal if the animal pulls on the leash.

FIG. 1 also exemplifies how the design of the present invention enables a user to vary the degree of restraint that the collar imposes on the animal when the animal pulls on the leash. As can be seen from FIG. 1, the degree of choking restraint that may be imposed upon the animal wearing the collar by attaching the leash to ring 4, 5, or 6 varies, respectively, according to the length of the link 1, 2, or 3 such that increasing the length of the link increases the amount of choking restraint that may be imposed on the animal. For example, when a user attaches a leash to ring 4 and thereafter the animal pulls on the leash, link 1 will slidably pass through ring 9 tightening the collar around the animal's neck and creating a choking force on the animal until stop 7 reaches ring 8. But note how link 1 is substantially longer than link 2, and link 2 is substantially longer than link 3. Because link 1 is the longest of links 1, 2, and 3, placing tension on ring 4 (i.e., when the animal pulls on the leash) and pulling link 1 through ring 9 results in the collar being most tightly fastened around the animal's neck (i.e., imposes the greatest degree of choking force on the animal). This is because link 1 being the longest of links 1, 2, and 3 means that stop 7 (which corresponds to a leash placed on ring 4) is the furthest stop from the ring disposed on the opposite end of the link. This results in link 1 being able to be tightened to the greatest degree before stop 7 contacts ring 8 to halt any increased application of choking force on the animal.

When a leash is attached to a ring that is affixed to a shorter link, such as rings 5 or 6, and an animal thereafter pulls on the leash, the shorter length of the link, such as links 2 or 3, only permits the collar to be tightened around the animal's neck to the extent that the shorter length link may be pulled until the stop, such as stops 8 or 9, reaches the ring through which the link is pulled. In the embodiment of the invention shown in FIG. 1, link 2 provides a “medium” amount of choking force as link 2 is shorter than link 1 but longer than link 3. Link 3, being the shortest link of collar 10 shown in FIG. 1, provides the least amount of choking force when someone pulls on a leash attached to ring 6.

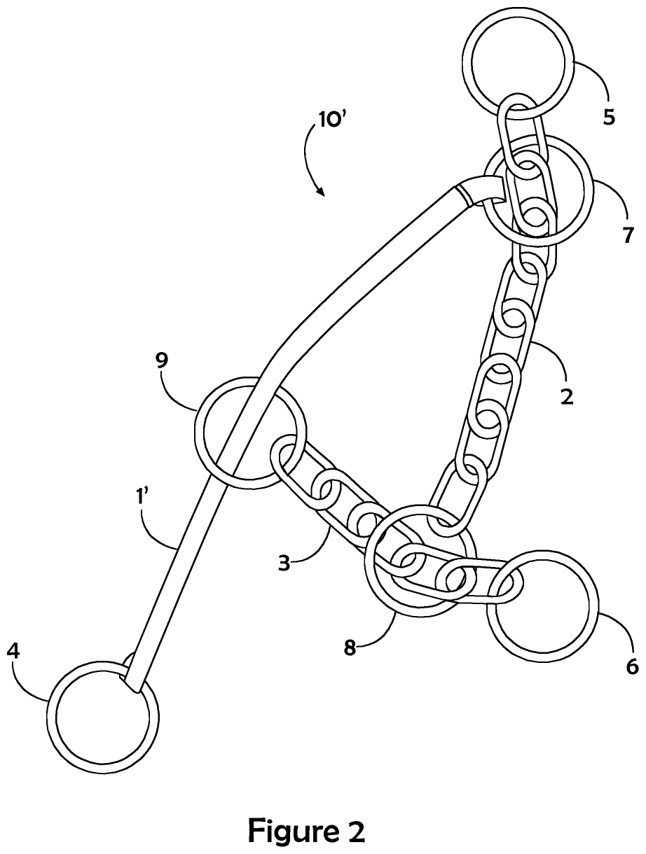

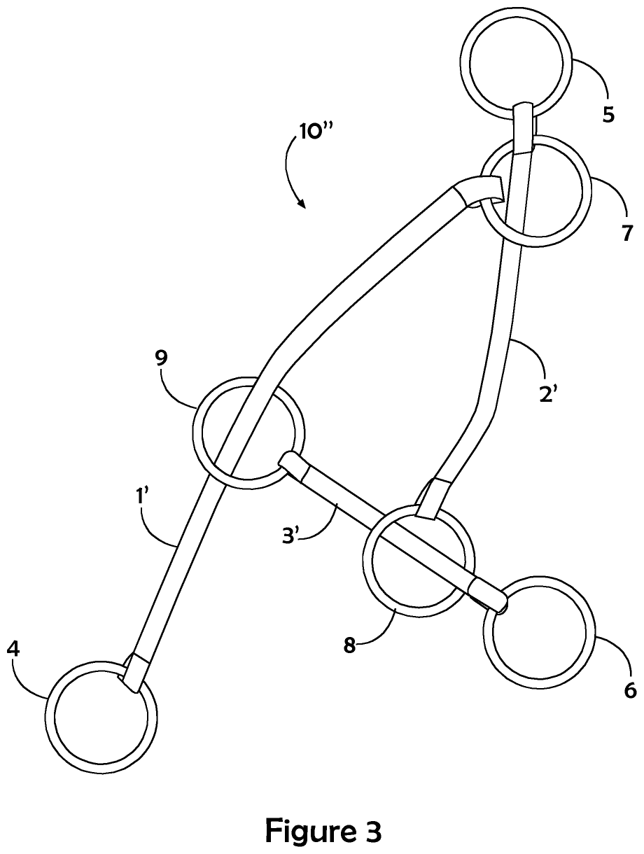

In alternate embodiments of the inventive collar, one or more of interconnecting links 1, 2, or 3 may be replaced by materials and/or forms other than steel chain. Referring now to FIG. 2, there is shown an alternate embodiment of the inventive collar 10′ wherein first connecting link (link 1 in FIG. 1) has been replaced by leather or nylon strap 1′. Referring now also to FIG. 3, all three interconnecting links 1″, 2″ and 3″ of inventive collar 10″ have been replaced by leather or nylon straps.

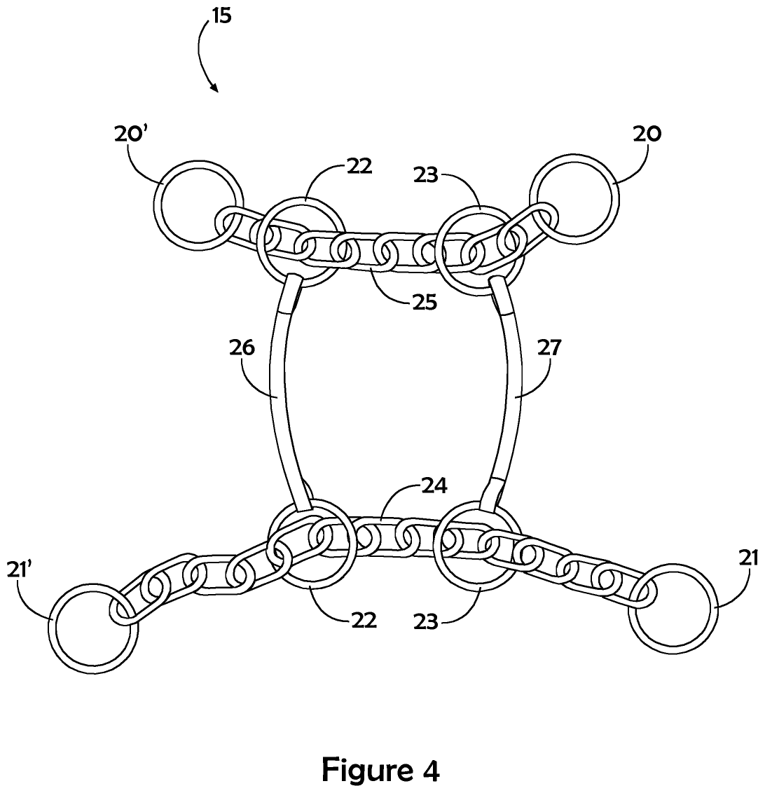

Referring now to FIG. 4, there is shown a perspective view of another alternate embodiment of the dog collar of the invention, generally at reference number 15. The embodiments of FIGS. 1, 2, and 3 are so-called three link embodiments as three links are provided. Referring now also to FIG. 4, yet another alternate embodiment of the inventive collar is shown. In FIG. 4, collar 15 has eight rings (four sets of two rings). If a user attaches a leash to rings 22 or 23, collar 15 imposes no significant choking force if the animal pulls on the leash. However, in similar fashion to the collar shown in FIG. 1, if a user attaches a leash to rings 20, 20′, 21 or 21′, the leash will impose a choking force if the animal pulls on the leash.

Collar 15 shown in FIG. 4 also enables the user to vary the degree of choking force imposed upon the animal according to the same principles that govern collar 10 disclosed in FIG. 1. For example, because link 24 is longer than link 25, attaching a leash to ring 21 or 21′ will result in the greatest choking force being applied if the animal pulls on the leash because link 24 will tighten around the animal's neck to a greater degree before the stop (in this case the stop being ring 21′ if the leash is attached to ring 21, or the stop being ring 21 if the leash is attached ring 21′) can halt the increase of the choking force. Because link 25 is significantly shorter than link 24, link 25 tightens around an animal's neck to a lesser degree before the stop (link 20 or 20′, depending on whether the leash is attached to link 20′ or 20, respectively) halts the increase of the choking force.

FIG. 4 also shows how links of the embodiment of the invention shown in FIG. 4 may alternately be fashioned from metal (such as links 24 and 25) or leather or nylon (such as links 26 and 27).

In operation, the multiple rings disposed on the embodiments of the present invention shown in FIGS. 1, 2, 3, and 4 permit a user to attach a leash to the collars shown in such Figures without a user needing to access the underside of the animal's neck. While the rings shown in the Figures are all substantially circular, such rings may be any shape. While substantially circular rings are thought to be the safest shape of the rings, as there are no sharp points that could potentially jab the animal or user of the collar, said rings may be of any shape that permits the collar to function as described herein, including but not limited to triangular rings, quadrangle rings, pentagonal rings, and hexagonal rings.

Since other modifications and changes varied to fit particular operating conditions and environments or designs will be apparent to those skilled in the art, the invention is not considered limited to the examples chosen for purposes of disclosure, and covers changes and modifications that do not constitute departures from the true scope of this invention.

Having thus described the invention, what is desired to be protected by Letters Patent is presented in the subsequently appended claims.

What is claimed is:

1. An animal collar, comprising:
a) at least three interconnecting links each interconnecting link having two ends with a ring affixed to each of said ends, each of said at least three interconnecting links having at least one of said rings slidably attached to at least one other of said at least three interconnecting links, said rings each being adapted for providing an attachment point for a leash or similar restraint, said rings being disposed around a perimeter of said collar;
b) wherein said rings affixed to the ends of any particular interconnecting link are unable to pass through the at least one of said rings that is slidably attached to the particular interconnecting link;
c) at least three of said rings providing substantially only restraint of an animal wearing said collar;
d) at least three other of said rings (“choking rings”) providing both restraint and choking force; and
e) wherein the choking force that results from attaching a leash to said choking rings varies according to the length of the interconnecting link to which the choking ring is attached.

2. The animal collar as recited in claim 1, further comprising stops that halt the amount of choking force that may be imposed upon an animal wearing the collar.

3. The animal collar as recited in claim 1, wherein at least one of said interconnecting links comprises a chain.

4. The animal collar as recited in claim 3, wherein said chain comprises a steel chain.

5. The animal collar as recited in claim 1, wherein at least one of said interconnecting links comprises a strap.

6. The animal collar as recited in claim 5, wherein said strap comprises at least one of the materials: leather and nylon.

7. The animal collar as recited in claim 1, wherein the at least three interconnecting links comprises exactly three interconnecting links.

8. The animal collar as recited in claim 1, wherein the at least three interconnecting links comprises exactly four interconnecting links.

9. The animal collar as recited in claim 3, wherein the at least three interconnecting links comprises exactly four interconnecting links.

10. The animal collar as recited in claim 5, wherein the at least three interconnecting links comprise exactly four interconnecting links.

11. The animal collar as recited in claim 8, wherein at least two of said interconnecting links comprise chain interconnecting links and two of said interconnecting links comprise strap interconnecting links.

12. The animal collar as recited in claim 1, wherein at least one of said rings is substantially circular in shape.

13. The animal collar as recited in claim 1, wherein at least one of said rings is a shape selected from the following group: triangular, quadrangle, pentagonal, or hexagonal.

14. The animal collar as recited in claim 5, further comprising stops that halt the amount of choking force that may be imposed upon an animal wearing the collar.
